(19) United States
(12) Patent Application Publication
(10) Pub. No.: US 2005/0150072 A1
(43) Pub. Date: Jul. 14, 2005

(54) Reinforcing element for a fixing part of a wiper arm

(76) Inventors: Michael Weiler, Chungchongbuk (KR); Joachim Zimmer, Sasbach (DE); Stefan Baumert, Karlsruhe (DE)

Correspondence Address: MICHAEL BEST & FRIEDRICH LLP, 100 EAST WISCONSIN AVENUE, MILWAUKEE, WI, 53202, US

(21) Appl. No.: 10/511,178

(22) PCT Filed: Apr. 15, 2003
(86) PCT No.: PCT/DE03/01266

(30) Foreign Application Priority Data
Aug. 3, 2002 (DE) 102 35 565.7

(51) Int. Cl. B60S 1/34

(52) U.S. Cl. 15/250.34; 15/250.31

(57) ABSTRACT

Windshield wiper device, in particular for a motor vehicle, with at least one wiper arm, which can be attached to an end area (21) of a shaft (20) by means of a fastening part (23) that is attached to it, wherein the fastening part (23) is provided with a reinforcing element (24) for optimal transmission of torque.

The invention relates to a windshield wiper device, in particular for a motor vehicle, with at least one wiper arm, which can be attached to an end area of a shaft by means of a fastening part that has been attached to it.

FIG. 1 shows a shaft 10 with a conical end 11 on which a fastening part 12 (known from the state of the art) of a wiper arm (not shown here in greater detail) is attached. The fastening part 12 is hindered from undesired loosening from the conical end 11 in the axial direction by means of screw 13. A washer 14 is arranged between the screw 13 and the fastening part 12 in order to avoid undesired loosening of the screw 13. Disadvantageous in the case of the fastening part 12 is that with improper assembly, for example, due to skewed attachment to the conical end 11, it is expanded too much, so that the transmission of torque from the shaft 10 to the fastening part 12 can be strongly restricted. In addition, experience has shown that even with proper assembly of the fastening part 12 on the shaft 10, optimal impressing of the knurls 15 attached to the conical end 11 cannot always be safely guaranteed. This is especially the case if the knurls are relatively blunt. The transmission of the torque between the shaft 10 and the fastening part 12 is also restricted in this case.

The object of the invention is improving a windshield wiper device of the type cited at the outset to the effect that, in the future, the torque is optimally transmitted between the shaft and fastening part.

The invention achieves the stated objective with a windshield wiper device, in particular for a motor vehicle, with at least one wiper arm, which can be attached to an end area of a shaft by means of a fastening part that is attached to it, whereby the fastening part is provided with a reinforcing element for optimal transmission of torque. Because of the fact that the fastening part is provided with a reinforcing element, undesired expansion of the fastening part from the shaft can be avoided in the future so that the torque can be reliably transmitted between the shaft and the fastening part, and namely independent of whether the fastening part was attached to the shaft in a skewed manner during assembly or not, since any assembly errors are equalized by the reinforcing element.

The reinforcing element features a simple geometry and is therefore also cost-effective in terms of manufacturing if it has a diameter to which it is symmetrical.

The advantages of the reinforcing element in accordance with the invention have a particularly good effect if it is attachable to a shaft with a conical end area, since the danger of undesired expansion of the reinforcing element is especially high in that case.

The reinforcing element is very simple structurally if it encloses the fastening part from the outside. In this connection, the reinforcing element can be pressed on the fastening part with a press fit. If the shaft features knurling on its end, the fastening part is pressed on the knurl by the reinforcing element, thereby creating a positive engaged connection between the fastening part and the end of the shaft. Because of this reliably acting, positively engaged connection, maximum torque can be transmitted between the shaft and the fastening part.

However, it is also possible for the fastening part to enclose the reinforcing element from the outside. In this case as well, undesired expansion of the fastening part is prevented by the reinforcing element. With this variation, the knurling on the end of shaft presses into the reinforcing element thereby guaranteeing an optimal transmission of torque.

If the reinforcing element features a polygonal outer contour, which engages in a corresponding polygonal opening of the fastening part, maximum torque can also be transmitted between the reinforcing element and the fastening part because of this positively engaged connection between the fastening part and the reinforcing element.

The reinforcing element can feature a round inner contour that is provided with smooth inner walls. Therefore, the knurling on the end of the shaft can press itself into the opening of the reinforcing element in the best possible manner and thereby guarantee optimal transmission of torque between the shaft and the reinforcing element. Since the fastening part is used to fasten a wiper arm of a windshield wiper device to a drive shaft of the wiper arm, adjustment into the optimal position (e.g., the wiper arm's parking position) can be accomplished without difficulty with the round opening of the wiper arm's reinforcing element that is provided with a smooth inner wall during initial assembly on the drive shaft before tightening the screw that fastens the fastening part to the end of the shaft. After adjustment, the knurling is pressed into the reinforcing element by tightening the screw that fastens the fastening part to the end of shaft. If the wiper arm must be reconnected to the end of the shaft by means of the fastening part, the original parking position can be found without difficulty due to the indentations pressed into the reinforcing element by the knurling on the end of the shaft.

In order to achieve a maximum transmission of torque between the shaft and the fastening part, if the fastening part encloses the reinforcing element from the outside, the reinforcing element can be fit into the fastening part via a press fit.

In order to prevent the reinforcing element from sliding off the end of the shaft axially, the reinforcing element can be axially caulked.

The reinforcing element is embodied in a particularly simple manner if it is a supporting ring.

The supporting ring can be manufactured simply and cost-effectively as a metal part, in particular a turned part or a diecast part.

It is also very simple in terms of manufacturing and very effective with respect to a maximum transmission of torque between the fastening part and the supporting ring if the supporting ring is an insert, around which is injection molded with plastic during the manufacture of the fastening part.

Exemplary embodiments of the reinforcing element in accordance with the invention are explained in more detail in the following on the basis of the enclosed drawings.

They shown in detail:

FIG. 1 An end of a shaft with an attached fastening part as known from the state of the art.

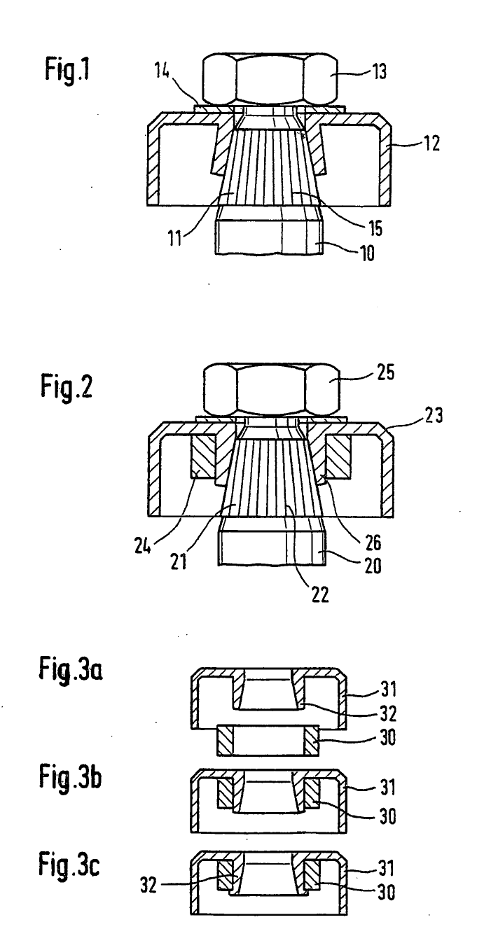

FIG. 2 A fastening part with a first embodiment of a reinforcing element in a mounted-together state.

FIG. 3a The fastening part and the reinforcing element from FIG. 2, each shown individually.

FIG. 3b The fastening part and the reinforcing element from FIG. 3a in an intermediate mounted state.

FIG. 3c The fastening part and the reinforcing element from FIG. 3a after caulking.

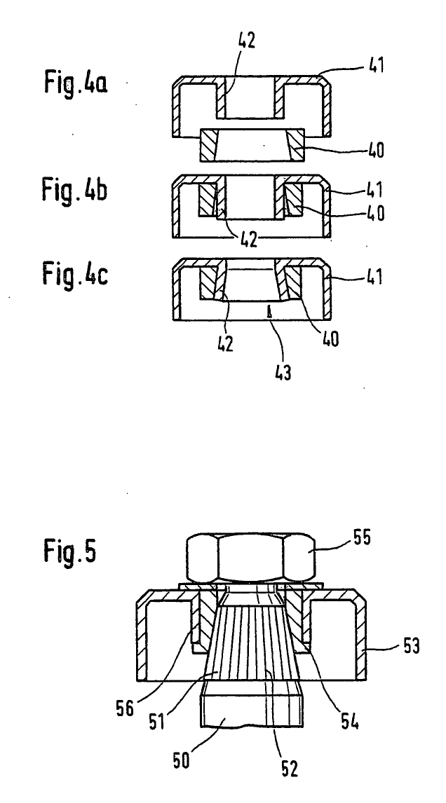

FIG. 4a A fastening part and a second embodiment of a reinforcing element, each shown individually.

FIG. 4b The fastening part and the reinforcing element from FIG. 4a in an intermediate mounted state.

FIG. 4c The fastening part and the reinforcing element in a finished, mounted state.

FIG. 5 A third embodiment of a reinforcing element in a mounted state.

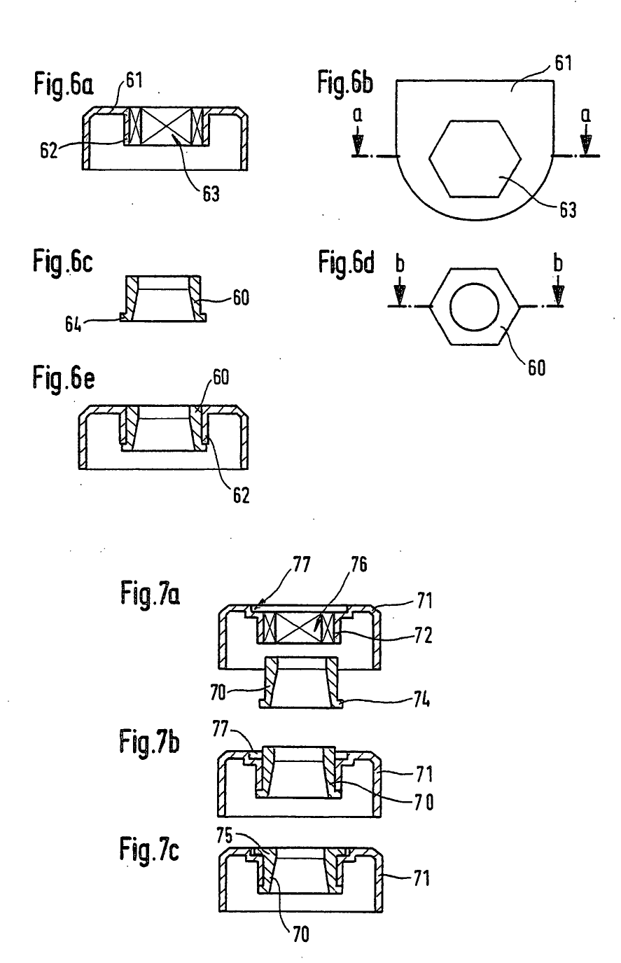

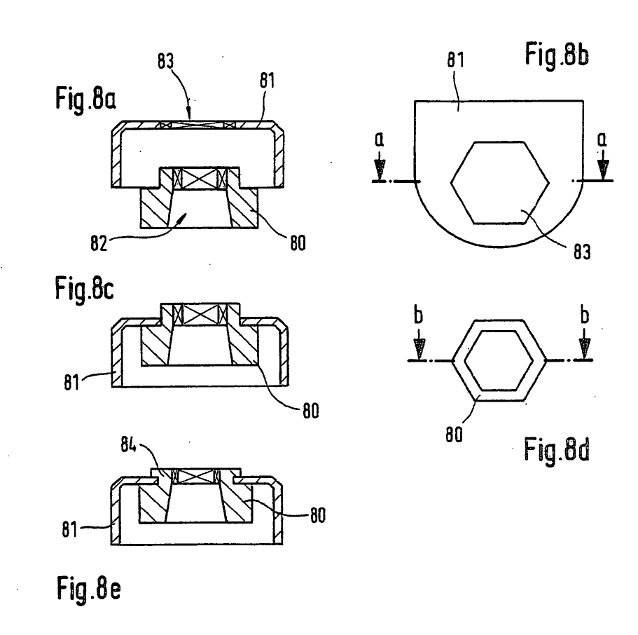

FIG. 6a A section through a fastening part from FIG. 6b.

FIG. 6b A top view of the fastening part from FIG. 6a.

FIG. 6c A section through the fastening part from FIG. 6d.

FIG. 6d A top view of the fastening part from FIG. 6c.

FIG. 6e The reinforcing element and the fastening part from FIGS. 6a and 6c after caulking.

FIG. 7a A fourth embodiment of a reinforcing element with the associated fastening part, each shown individually.

FIG. 7b The fastening part and the reinforcing element from FIG. 7a in an intermediate mounted state.

FIG. 7c The fastening part and the reinforcing element from FIG. 7b after caulking.

FIG. 8a A fifth embodiment of a reinforcing element with the associated fastening part, each shown individually.

FIG. 8b A top view of the fastening part from FIG. 8a.

FIG. 8c The fastening part and the reinforcing element from FIG. 8a in an intermediate mounted state.

FIG. 8d A top view of the reinforcing element from FIG. 8a.

FIG. 8e The reinforcing element and the fastening part from FIG. 8c after caulking.

FIG. 2 shows a shaft 20 with a conical shaft end 21 on which knurls 22 are attached. A fastening part 23 is slid onto the conical shaft end 21. The fastening part 23 is enclosed by a reinforcing element 24. A screw 25 fixes the fastening part 23 in the axial direction of the shaft 20. The reinforcing element 24 prevents an edge 26 adjacent to the conical end 21 from undesired expansion. As a result, the edge 26 is pressed against the conical end 21 by the reinforcing element 24, whereby the torque to be transmitted between the shaft 20 and the fastening part 23 can be transmitted in an optimal manner. In addition, the fastening part 23 is pressed into the knurls 22 by the reinforcing element 24. This is of special significance in the case of repairs if the fastening part 23 has to be remounted on the shaft 20. Because the knurls 22 are pressed into the edge 26, corresponding indentations are created in the edge 26 into which the knurls 22 can engage during the remounting process. As a result, the original position of a wiper arm attached to the fastening part 23 can be located easily.

FIGS. 3a through 3c show the simple and quick progression of assembly of a reinforcing element 30 on a fastening part 31. During assembly, the reinforcing element 30 is slid over an edge 32 of the fastening part 31 (see FIGS. 3a and 3b). Then the fastening part 31 is axially caulked on the end of its edge 32 in order to safely keep the reinforcing element 30 from sliding off the fastening part 31 in the axial direction. As a result, the caulked fastening part 31 prevents the reinforcing element 30 from slipping off the fastening part 31, and the reinforcing element 30 prevents the fastening part 31 from undesired expansion in the area of its edge 32 (see FIG. 3c).

FIGS. 4a through 4c show a reinforcing element 40, which is slid over an edge 42 of a fastening part 41 (see FIGS. 4a and 4b). After the reinforcing element 40 has been slid on the edge 42 of the fastening part 41, the conical end of a shaft (not shown here in more detail) is slid into an opening 43 formed by the edge 42. In doing so, the edge 42 is expanded conically in accordance with the conical shape of the inserted shaft end until it is adjacent to the inner walls of the reinforcing element 40, which also run conically. In this way, the edge 42 prevents the reinforcing element 40 from slipping off axially from the edge 42 and the reinforcing element 40 prevents the edge 42 from undesired expansion.

FIG. 5 shows a shaft 50 with a conical shaft end 51 on which knurls 52 are attached. A reinforcing element 54 is attached to the conical shaft end 51 and a fastening part 53 is attached to the reinforcing element 54, and it encloses the reinforcing element 54 with an edge 56. A screw 55 prevents the fastening part 53 and the reinforcing element 54 from sliding axially off the shaft 50. The reinforcing element 54 has a round opening provided with smooth inner walls into which the conical shaft end 51 is inserted. The knurls 52 are pressed into the material of the reinforcing element 54 by tightening the screw 55. As a result, the assembly personnel can adjust the optimal parking position of the wiper arm on the shaft 50 during initial mounting of the fastening part 53 (to which a wiper arm—not shown here in more detail—of a windshield wiper device is attached). After the adjustment of the wiper arm, the fastening part 53 is fixed on the shaft 50 by tightening the screw 55, thereby pressing the knurls 52 into the material of the reinforcing element 54. If, after a repair, the fastening part 53 is supposed to be remounted on the conical end 51 of the shaft 50, the original optimal parking position of the wiper arm can easily be located again because of the indentations pressed into the reinforcing element 54 by the knurls 52.

FIGS. 6a and 6b show a fastening part 61 with an edge 62. The end 62 forms a hexagonal opening 63 into which a reinforcing element 60 that also has a hexagonal outer contour can be pressed (see FIGS. 6c and 6d). The reinforcing element 60 is inserted into the opening 63. When inserting the reinforcing element 60 into the fastening part 61, an edge 64 of the reinforcing element 60 hits the lower end of the edge 62 and thus prevents the reinforcing element 60 from being pressed out the other side of the fastening part 61 when it is being inserted into the fastening part 61 (see FIG. 6e).

FIGS. 7a through 7c show the progression of assembly of a reinforcing element 70 with a fastening part 71. The fastening part 71 has an edge 72, which forms a hexagonal opening 76 into which the reinforcing element 70 that is provided with a hexagonal outer contour is inserted. The reinforcing element 70 is inserted so far into the opening 76 until a protuberance 74 on the reinforcing element 70 hits the lower end of the edge 72 (see FIGS. 7a and 7b). Then the upper edge of the reinforcing element 70 that projects over the fastening part 71 is caulked so that a resulting protuberance 75 is pressed into a depression 77. As a result, the reinforcing element 70 is prevented from sliding out of the fastening part 71 in both axial directions.

FIGS. 8a through 8e show the progression of assembly of a reinforcing element 80 with a fastening part 81. The reinforcing element 80 features a conical opening 82 into which a conical end of a shaft (not shown in detail here) can be introduced. During assembly, the reinforcing element 80 is inserted into a hexagonal opening 83 of the fastening part 81 (see FIG. 8c). The reinforcing element 80 features an outer hexagonal contour, which engages in a hexagonal contour of the opening 83 of the fastening part 81. Because of this positively engaged connection between the reinforcing element 80 and the fastening part 81, a very high torque can be transmitted between the reinforcing element 80 and the fastening part 81. The reinforcing element 80 also features a hexagonal inner contour in its upper area into which a hexagonal outer contour of a shaft to be inserted into the reinforcing element 80 can engage. As a result, a high torque can also be optimally transmitted between the shaft (not shown in more detail) and the reinforcing element 80. After inserting the reinforcing element 80 into the fastening part 81, an edge of the reinforcing element 80 (see FIG. 8c) projecting upward above the fastening part 81 is caulked (see FIG. 8e) so that the reinforcing element 80 forms a protuberance 84, which prevents the reinforcing element 84 [translator's note: this is probably a typographical error for “80”] from sliding out of the fastening part 81 in both axial directions. Since the fastening part 81 does not feature a deep-drawn edge as with the exemplary embodiments described in the foregoing, the exemplary embodiment described in FIGS. 8a through 8e is particularly well suited for non-articulated wiper arms in which attaching a deep-drawn edge in the fastening part 81 is not customary, since this would only be possible with an increased manufacturing expense, for example, via heat treatment.

1. Windshield wiper device, in particular for a motor vehicle, with at least one wiper arm, which can be attached to an end area (21, 51) of a shaft (20, 50) by means of a fastening part (23, 31, 41, 53, 61, 71, 81) that is attached to it, characterized in that the fastening part (23, 31, 41, 53, 61, 71, 81) is provided with a reinforcing element (24, 30, 40, 54, 60, 70, 80) for optimal transmission of torque.

2. Windshield wiper device according to claim 1, characterized in that the reinforcing element (24, 30, 40, 54, 60, 70, 80) features a diameter to which it is symmetrical.

3. Windshield wiper device according to claim 1, characterized in that the reinforcing element (24, 30, 40, 54, 60, 70, 80) is attachable to a shaft (20, 50) whose end area (21, 51) is conical.

4. Windshield wiper device according to claim 1, characterized in that the reinforcing element (24, 30, 40) encloses the fastening part (53, 61, 71, 81) from the outside.

5. Windshield wiper device according to claim 1, characterized in that the fastening part (53, 61, 71, 81) encloses the reinforcing element (54, 60, 70, 80) from the outside.

6. Windshield wiper device according to claim 5, characterized in that the reinforcing element (54, 60, 70, 80) features a polygonal outer contour.

7. Windshield wiper device according to claim 5, characterized in that the reinforcing element (54, 60, 70, 80) features an opening with a round inner contour that is provided with a smooth inner wall.

8. Windshield wiper device according to claim 5, characterized in that the reinforcing element (54, 60, 70, 80) is fit into the fastening part (53, 61, 71, 81) via a press fit.

9. Windshield wiper device according to claim 1, characterized in that the reinforcing element (70, 80) can be axially caulked.

10. Windshield wiper device according to claim 1, characterized in that the reinforcing element (24, 30, 40, 54, 60, 70, 80) is a supporting ring.

11. Windshield wiper device according to claim 10, characterized in that the supporting ring is a metal part, in particular a turned part or a diecast part.

12. Windshield wiper device according to claim 10, characterized in that the supporting ring is an insert, around which it is possible to injection mold with plastic to manufacture the fastening part (23, 31, 41, 53, 61, 71, 81).

13. Windshield wiper device according to claim 2, characterized in that the reinforcing element (24, 30, 40, 54, 60, 70, 80) is attachable to a shaft (20, 50) whose end area (21, 51) is conical.

14. Windshield wiper device according to claim 2, characterized in that the reinforcing element (24, 30, 40) encloses the fastening part (53, 61, 71, 81) from the outside.

15. Windshield wiper device according to claim 3, characterized in that the reinforcing element (24, 30, 40) encloses the fastening part (53, 61, 71, 81) from the outside.

16. Windshield wiper device according to claim 2, characterized in that the fastening part (53, 61, 71, 81) encloses the reinforcing element (54, 60, 70, 80) from the outside.

17. Windshield wiper device according to claim 3, characterized in that the fastening part (53, 61, 71, 81) encloses the reinforcing element (54, 60, 70, 80) from the outside.

18. Windshield wiper device according to claim 6, characterized in that the reinforcing element (54, 60, 70, 80) is fit into the fastening part (53, 61, 71, 81) via a press fit.

19. Windshield wiper device according to claim 7, characterized in that the reinforcing element (54, 60, 70, 80) is fit into the fastening part (53, 61, 71, 81) via a press fit.

20. Windshield wiper device according to claim 11, characterized in that the supporting ring is an insert, around which it is possible to injection mold with plastic to manufacture the fastening part (23, 31, 41, 53, 61, 71, 81).
